(19) United States
(12) Patent Application Publication
(10) Pub. No.: US 2021/0256584 A1
(43) Pub. Date: Aug. 19, 2021

(54) SYSTEM AND METHOD FOR INTERMEDIATING ELECTRONIC COMMERCE BETWEEN SUPPLIER AND SELLER

(71) Applicant: Chung Jong LEE, Gangwon-do (KR)

(72) Inventor: Chung Jong LEE, Gangwon-do (KR)

(21) Appl. No.: 17/049,275

(22) PCT Filed: May 3, 2019
(86) PCT No.: PCT/KR2019/005340

§ 371 Date: Oct. 20, 2020

(30) Foreign Application Priority Data
May 4, 2018 (KR) 10-2018-0051859

(51) Int. Cl. G06Q 30/06; G06Q 10/08

(52) U.S. Cl. CPC G06Q 30/0619; G06Q 10/0833; G06Q 30/0633; G06Q 30/0641

(57) ABSTRACT

A system for intermediating an electronic commerce between a supplier and a seller includes a central management server configured to manage supply product and service information received from a supplier and sale product information received from a seller, a payment management server configured to manage a deposit of the seller, a purchase product information of a purchaser, and a settlement amount of the supplier, an intermediation core DB server configured to make a database of the supply product and service information, the sale product information, the purchase product information, the deposit, and the settlement amount and to store the database, an intermediation core web server configured to provide an intermediation core web page, and a web server of the seller configured to provide a web page of the seller, whereby transactions may be made with multiple sellers even if multiple supplies upload only a list of supply products and services, and thus supply products and services of the suppliers may be traded actively and supply product and service distribution channels may be easily diversified.

### BACKGROUND OF THE DISCLOSURE

### Technical Field

The present disclosure relates to a system for intermediating an electronic commerce between multiple suppliers and multiple sellers, and more particularly, to an electronic commerce intermediating system and method allowing multiple sellers to directly select products and services supplied by multiple suppliers and sells the selected products or services to multiple purchasers in a peer-to-peer (P2P) manner.

### Background Art

Recently, transactions of products or services between companies and consumers have been made through electronic commerce (EC). In general, electronic commerce refers to performing purchase, procurement, and paying on products and information in an electronic manner through the Internet and electronic devices. Such an electronic commerce system opens a cyber market on the Internet, arranges an electronic catalog or the like and then displays products so that general purchasers may purchase the products. Since sites thereof are realized based on sellers, transactions between suppliers and sellers are not actively made. In addition, since the system that intermediates an electronic commerce merely opens electronic commerce sites of multiple sellers in a mall-In-mall manner, multiple manufacturers or distributors supplying products and services have a difficulty in securing multiple sellers and even multiple sellers has a difficulty in securing a quantity in stock of a target product to sell.

(Patent document 1) Korean Patent Laid-Open Publication No. 10-2010-0089760 (Publication date: Aug. 12, 2010)

### SUMMARY

### Technical Problem

An aspect of the present disclosure provides a system and method for intermediating an electronic commerce between multiple suppliers and multiple sellers, whereby multiple suppliers (manufacturers or distributors) may secure multiple sellers by providing only a list of supply products and services without having to directly look for sellers and multiple sellers may stably secure a quantity in stock of products to sell.

### Technical Solution

According to various embodiments of the present disclosure, a system for intermediating an electronic commerce between a supplier and a seller includes: a central management server configured to manage supply product and service information received from a supplier and sale product information received from a seller, a payment management server configured to manage a deposit of the seller, a purchase product information of a purchaser, and a settlement amount of the supplier, an intermediation core DB server configured to make a database of the supply product and service information, the sale product information, the purchase product information, the deposit, and the settlement amount and to store the database, an intermediation core web server configured to provide an intermediation core web page, and a web server of the seller configured to provide a web page of the seller, wherein the intermediation core web server is configured to receive the supply product and service information input from the supplier through the intermediation core web page, to provide the supply product and service information to the seller through the intermediation core web page, to receive the sale product information input from the seller through the intermediation core web page, and to transmit the sale product information to the web server of the seller so that the sale product information is linked to the web page of the seller.

According to various embodiments of the present disclosure, a method of intermediating an electronic commerce between a supplier and a seller of an electronic commerce intermediating system including a central management server configured to manage supply product and service information received from a supplier and sale product information received from a seller, a payment management server configured to manage a deposit of the seller, a purchase product information of a purchaser, and a settlement amount of the supplier, an intermediation core DB server configured to make a database of the supply product and service information, the sale product information, the purchase product information, the deposit, and the settlement amount and to store the database, an intermediation core web server configured to provide an intermediation core web page, and a web server of the seller configured to provide a web page of the seller, includes: receiving the supply product and service information input from the supplier through the intermediation core web page, providing supply product and service information to the seller through the intermediation core web page, receiving the sale product information (or product information for sale) input from the seller through the intermediation core web page, and transmitting the sale product information to the web server of the seller so that the sale product information is linked to the web page of the seller.

### Advantageous Effects

As described above, in the system for intermediating an electronic commerce between a supplier and a seller according to the present disclosure, transactions may be made with multiple sellers even if multiple supplies upload only a list of supply products and services, and thus transactions of the supply products and services of the suppliers may be promoted and distribution channels for supply products and services may be easily diversified.

Furthermore, multiple suppliers and multiple sellers may obtain effects of securing new customers and reducing operating cost.

Furthermore, since multiple suppliers may receive settlement amount for the sale of a supply product and service from deposits paid by multiple sellers, safe transactions may be made and stable sales may be secured.

Furthermore, multiple sellers may easily secure a stock quantity of target products through the intermediation core web page.

Furthermore, multiple suppliers and multiple sellers may secure reliable customers through the electronic commerce intermediating system of the present disclosure.

In addition, multiple sellers may secure web pages on which target products may be easily sold through an artificial intelligence server.

### BRIEF DESCRIPTION OF THE DRAWINGS

FIG. 1 is a block diagram illustrating an electronic commerce intermediating system according to an embodiment of the present disclosure.

FIG. 2 is a flowchart illustrating an electronic commerce intermediating system according to an embodiment of the present disclosure.

FIG. 3 is a flowchart illustrating a system for intermediating an electronic commerce among an intermediation core, a supplier, and a seller according to an embodiment of the present disclosure.

FIG. 4 is a flowchart illustrating a purchase restriction of a seller based on a seller's deposit and a total amount limit according to an embodiment of the present disclosure.

FIG. 5 is a flowchart illustrating a payment limit of a purchaser in accordance with a deposit of a seller and a reference amount according to an embodiment of the present disclosure.

FIG. 6 is a flowchart illustrating an operation of an artificial intelligence server in an electronic commerce intermediating system according to an embodiment of the present disclosure.

FIG. 7 is a block diagram illustrating an electronic commerce intermediating system according to another embodiment of the present disclosure.

FIG. 8 is a block diagram illustrating an electronic commerce intermediating system according to another embodiment of the present disclosure.

FIG. 9 is a block diagram illustrating an electronic commerce intermediating system according to another embodiment of the present disclosure.

FIG. 10 is a block diagram illustrating an electronic commerce intermediating system according to another embodiment of the present disclosure.

### BEST MODE

According to an aspect of the present disclosure, a system for intermediating an electronic commerce between a supplier and a seller includes: a central management server configured to manage supply product and service information received from a supplier and sale product information received from a seller, a payment management server configured to manage a deposit of the seller, a purchase product information of a purchaser, and a settlement amount of the supplier, an intermediation core DB server configured to make a database of the supply product and service information, the sale product information, the purchase product information, the deposit, and the settlement amount and to store the database, an intermediation core web server configured to provide an intermediation core web page, and a web server of the seller configured to provide a web page of the seller, wherein the intermediation core web server is configured to receive the supply product and service information input from the supplier through the intermediation core web page, to provide the supply product and service information to the seller through the intermediation core web page, to receive the sale product information input from the seller through the intermediation core web page, and to transmit the sale product information to the web server of the seller so that the sale product information is linked to the web page of the seller.

### MODE FOR CARRYING OUT THE INVENTION

Hereinafter, various embodiments of the present disclosure will be described in detail with reference to the accompanying drawings. In the following description, when a detailed description of the relevant known functions or configurations is determined to unnecessarily obscure the gist of the present disclosure, the detailed description will be omitted. The terms used henceforth are defined in consideration of the functions of the disclosure and may be altered according to the intent of a user or operator, or conventional practice. Therefore, the terms should be defined on the basis of the entire content of this disclosure.

Embodiments of an electronic commerce intermediating system according to the present disclosure will be described with reference to the accompanying drawings. However, the present disclosure is not limited to the following exemplary embodiments but may be implemented in various different forms. The exemplary embodiments are provided only to complete disclosure of the present disclosure and to fully provide a person having ordinary skill in the art to which the present disclosure pertains with the category of the disclosure.

Various embodiments of the disclosure may be implemented by software (e.g., the program) including an instruction stored in a machine-readable storage media (e.g., an internal memory or an external memory) readable by a machine (e.g., a computer). The machine may be a device that calls the instruction from the machine-readable storage media and operates depending on the called instruction and may include the electronic device (e.g., the electronic device). When the instruction is executed by the processor (e.g., the processor), the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

In accordance with an aspect of the disclosure, it may be provided as a part of a computer program product. The computer program product may be traded between a seller and a purchaser as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or an intermediation server.

Each component (e.g., the module or the program) according to various embodiments may include at least one of the above components, and a portion of the above sub-components may be omitted, or additional other sub-components may be further included. Alternatively or additionally, some components (e.g., the module or the program) may be integrated in one component and may perform the same or similar functions performed by each corresponding components prior to the integration. Operations performed by a module, a programming, or other components according to various embodiments of the disclosure may be executed sequentially, in parallel, repeatedly, or in a heuristic method. Also, at least some operations may be executed in different sequences, omitted, or other operations may be added.

In addition, although an object of a transaction is referred to an article or goods in this disclosure, it is not necessarily limited to a product and it may target human services such as job service, tax service, and legal service. In addition, it should be noted in advance that a target object of a transaction can be extended to any object where the transaction can be made.

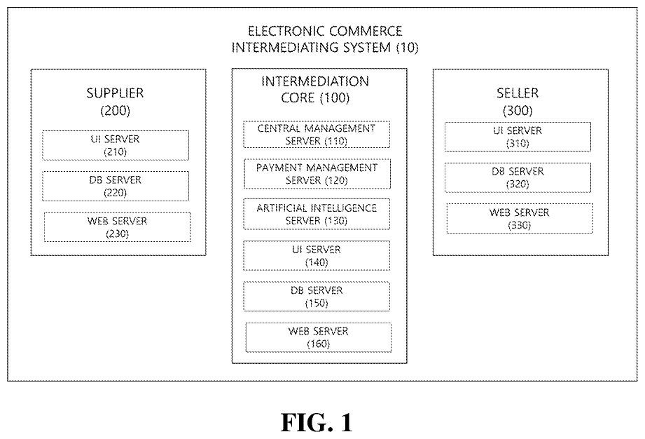

FIG. 1 is a block diagram illustrating an electronic commerce intermediating system according to an embodiment of the present disclosure.

Referring to FIG. 1, an electronic commerce transaction among a supplier, a seller, and a purchaser according to the present disclosure may be performed through an electronic commerce intermediating system 10. Here, the supplier and the seller have a concept including multiple suppliers and multiple sellers, and the supplier has a concept including multiple manufacturers or multiple distributors. For example, the supplier and the seller may register as a member in the electronic commerce intermediating system 10 through an intermediation core web page, the supplier may register supply products and services manufactured by himself or herself or wholesale products and services distributed by himself or herself, and the seller may view, retrieve, select, and sell the registered supply products and services. Here, the supply products have a concept including manufactured products, content, wholesale products, or distributed products. In addition, services have a concept including various services that may be provided by humans. For example, services may refer to services that may be provided by an instructor, a singer, or a freelance translator.

The electronic commerce intermediating system 10 according to an embodiment of the present disclosure may include an intermediation core 100 part, a supplier 200 part, and a seller 300 part. The supplier 200 part and the seller 300 part may perform a transaction through the intermediation core 100 part. The intermediation core 100 part, the supplier 200 part, and the seller 300 part may have a concept classified based on a subject operating multiple servers included in the electronic commerce intermediating system, and devices in which the electronic commerce intermediating system 10 of the present disclosure operate may be servers disclosed in FIG. 1, respectively, to be described below.

In an embodiment, the supplier 200 and the seller 300 may be entities that run a business without being limited to any part of the world. For example, both a business area of the supplier 200 and a business area of the seller 300 may target the world.

In an embodiment, multiple servers each belonging to the intermediation core 100 part, the supplier 200 part, and the seller 300 part may communicate with each other via a network. Here, the network may include a wireless network and a wired network. For example, the network may be a short-range communication network (e.g., Bluetooth, Wi-Fi direct, or IrDA (infrared data association)) or a telecommunication network (e.g., a cellular network, the Internet, or a computer network (e.g., LAN or WAN)).

In an embodiment, the intermediation core 100 part may include a central management server 110, a payment management server 120, an artificial intelligence server 130, a UI server 140, a database (DB) server 150, and a web server 160. The central management server 110, the payment management server 120, the artificial intelligence server 130, the UI server 140, the DB server 150, and the web server 160 may be linked to each other, and Information obtained by each server may be updated to the DB server 150. For example, when the supplier 200 registers supply products and services and the seller 300 selects some of the supply products and services as sale products or services, it may be considered that a first contract is established between the supplier 200 and the seller 300. Thereafter, when part of a deposit of the seller 300 is transferred to the supplier 200 as a settlement amount after the purchaser purchases a sale product (or a product for sale), it may be considered that a second contract is established and the entire transaction contract is completed. Here, as the settlement amount is transferred to the supplier 200, the deposit is reduced by the transmitted settlement amount.

For example, the central management server 110 may manage the supply product and service information received from the web server 230 of the supplier 200 and the sale product received from the web server 330 of the seller 300 and update the DB server 150. In addition, the central management server 110 may collectively update multiple supply product and service information obtained from multiple suppliers 200 and multiple sale product information obtained from multiple sellers 300 to the DB server 150 and analyze the same and process the analyzed information into new type of information. For example, the new type of information may include the latest trend of supply products of the supplier 200, the latest trend of products that the seller 300 wants to sell, and the like.

In an embodiment, when a request for modification of the supply product and service information from the supplier 200 is received or additional supply product and service information is registered, the central management server 110 may update the same to the DB server 150 in real time and inform the web server 330 of the seller 300 accordingly.

For example, the supply product and service information may include a description of a supply product and service, a quantity in stock, the number of available service providers, a supply price, a consumer price, a delivery charge, or a category, and the like. For example, the description of the supply product and service may include a company name of the supplier 200, a country name and an address of the supplier 200, business information of the supplier 200, transaction condition information on conditions (e.g., new, used, lease) of supply products, specifications of supply products and services, design, and conditions of services (e.g., service provision content, provision time, number of provided people), and the like.

For example, the sale product information may include a name of a product selected by the seller 300 among the supply products and services, service contents of the service, the number of service personnel, the quantity of supplied products, the company name and address of the seller 300, business information of the seller 300, and the like.

For example, the payment management server 120 may store and manage the deposit of the seller, the purchase product information of the purchaser, and the settlement amount of the supplier.

For example, the purchase product information may include a purchase product name of the purchaser, a quantity, and payment price.

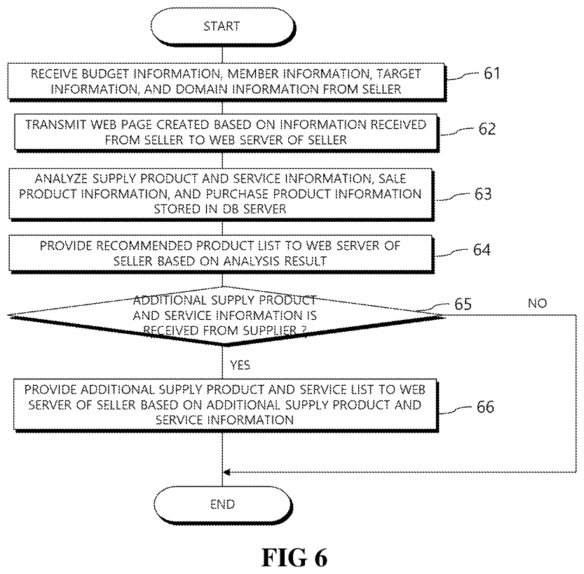

For example, the artificial intelligence server 130 may create a web page appropriate for the seller 300 by analyzing a huge amount of big data stored as a database in the DB server 150 of the intermediation core 100, the DB server 220 of the supplier 200, and the DB server 320 of the seller 300. Details of the operation of the artificial intelligence server 130 will be described later in FIG. 6.

For example, the UI server 140 may create and store menus, buttons, texts, banners, and the like of a screen configuring an intermediation core web page, and provide the same to the web server.

For example, the DB server 150 may make a database of supply product and service information, sale product information, purchase product information, and settlement amount and store the same.

For example, the web server 160 may provide an intermediation core web page to the supplier 200 and the seller 300. Here, the intermediation core web page may be a web site that the supplier 200 and the seller 300 may access online. The web server 160 may provide a means for the supplier 200 to register supply product and service information through the intermediation core web page, display a list of supply products and services on the intermediation core web page, and provide a means for searching and selecting multiple supply products and services included in the supply product and service information to the seller 300. In addition, the web server 160 may link sale product information corresponding to a result of selecting a supply product and service of the seller 300 to the web page of the seller 300. In addition, the web server 160 may update in real time registration of the supply products and services of the supplier 200, selection of a sale product of the seller 300, selection of a purchase product of the purchaser, and the like, and link the same to the web server 230 of the supplier 200 and the web server 330 of the seller 300 in real time.

In an embodiment, the supplier 200 part may include a UI server 210, a DB server 220, and a web server 230. The UI server 210, the DB server 220, and the web server 230 may be linked to each other, and information obtained by each server may be updated to the DB server 220.

For example, the UI server 210 may create and store menus, buttons, text, banners, and the like of a screen configuring a web page of the provider 200 and provide the same to the web server 230. For example, since the supplier 200 may exist all over the world, the supply products or services of the supplier 200 may include a language used in a corresponding country, a design unique to the corresponding country, and a UI.

For example, the DB server 220 may make a database of a supply product and service information, purchase product information, and settlement amount and store the same.

For example, the web server 230 may communicate with the web server of the intermediation core 100 and may provide a web page of the provider 200. In addition, the web server 230 may provide a language suitable for the supplier 200 (e.g., the language of the country in which the supplier 200 does business) existing in various places globally, design, and a UI to the web server 160, the UI server 140, or the DB server 150 of the intermediation core 100.

In an embodiment, the seller 300 part may include a UI server 310, a DB server 320, and a web server 330. The UI server 310, the DB server 320, and the web server 330 may be linked to each other, and information obtained by each server may be linked to the DB server 320.

For example, the UI server 310 may create and store menus, buttons, text, banners, and the like of a screen configuring a web page of the seller 300 and provide the same to the web server 330.

For example, the DB server 320 may make a database of a sale product information, purchase product information, and a deposit and store the same.

For example, the web server 330 may communicate with the web server 160 of the intermediation core 100 and provide a web page of the seller 300.

The electronic commerce intermediating system 10 configured as described above may be a mall in mall in mall application server program (ASP) system. Here, the mall in mall in mall ASP system refer to a system in which the web pages of multiple sellers 300 provided through the intermediation core 100 all provide supply products or services through the same intermediation server called the intermediation core 100 but multiple purchasers may not know the intermediation core 100 and may simply recognize that multiple web pages of multiple different sellers 300 exist. That is, from the point of view of the purchaser, the web pages of the sellers 300 may be recognized as independent sellers 300 that are not related to each other even though they use the same intermediation server, and such a system may be referred to as mall in mall in mall ASP.

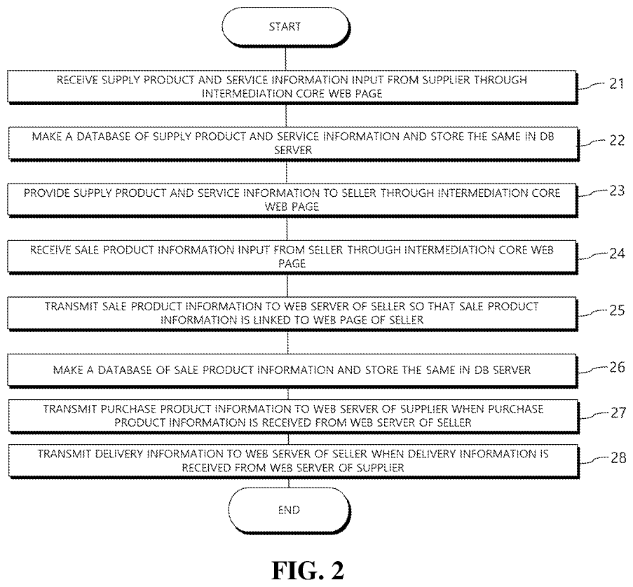

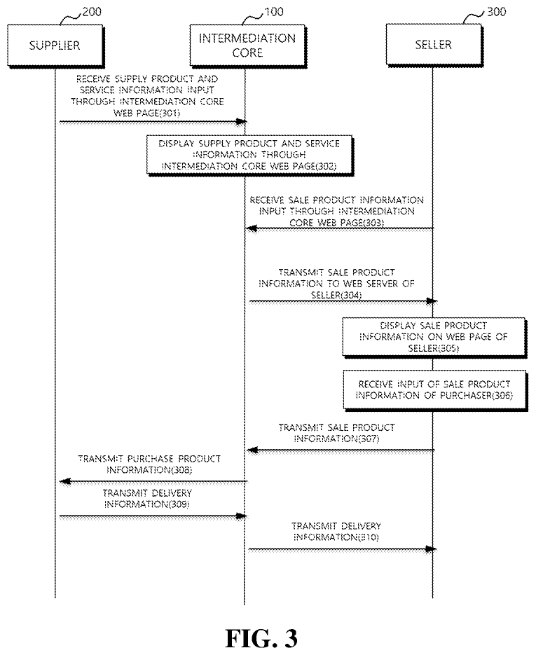

FIG. 2 is a flowchart illustrating an electronic commerce intermediating system according to an embodiment of the present disclosure. FIG. 3 is a flowchart illustrating a system for intermediating an electronic commerce among an intermediation core, a supplier, and a seller according to an embodiment of the present disclosure. Hereinafter, an embodiment of the electronic commerce intermediating system of the present disclosure will be described with reference to FIGS. 2 and 3.

Referring to FIGS. 2 and 3, in an embodiment, the electronic commerce intermediating system 10 may receive an input of supply product and service information from the supplier 200 through the intermediation core web page in operation 21. For example, the web server 160 of the intermediation core 100 may receive the supply product and service information through the intermediation core web page, store the same, and transmit the received information to the DB server 150 (operation 301 of FIG. 3).

As described above, for example, the supply product and service information may include a description of a supply product and service, a quantity in stock, the number of available service providers, a supply price, a consumer price, a delivery charge, or a category, and the like. For example, the description of the supply product and service may include a company name of the supplier 200, a country name and an address of the supplier 200, business information of the supplier 200, transaction condition information on conditions (e.g., new, used, lease) of supply products, specifications of supply products and services, design, and conditions of services (e.g., service provision content, provision time, number of provided people), and the like.

In an embodiment, in operation 22, the electronic commerce intermediating system 10 may make a database of the supply product and service information and store the same in the DB server 160. For example, the DB server 150 of the intermediation core 100 may make a database of the supply product and service information received from the web server 150 and store the same.

In an embodiment, in operation 23, the electronic commerce intermediating system 10 may provide the supply product and service information to the seller 300 through the intermediation core web page. For example, the web server 160 may display supply product and service information in the form of a list on the intermediation core web page so that the seller 300 may select one or more of supply product and service through the intermediation core web page (operation 302 in FIG. 3).

In an embodiment, in operation 24, the electronic commerce intermediating system 10 may receive an input of sale product information from the seller 300 through an intermediation core web page. For example, the web server 160 may receive an input of the seller 300 that selects at least one or more of a list of supply product and service information through an intermediation core web page (operation 303 of FIG. 3). The web server 160 may transmit sale product information to the DB server 150.

As described above, for example, For example, the sale product information may include a name of a product selected by the seller 300 among the supply products and services, service contents of the service, the number of service personnel, the quantity of supplied products, the company name and address of the seller 300, business information of the seller 300, and the like.

In an embodiment, in operation 25, the electronic commerce intermediating system 10 may transmit the sale product information to the web server 330 of the seller 300 so that the sale product information is linked to the web page of the seller 300. For example, the web server 160 of the intermediation core 100 may transmit related data to the web server 330 of the seller 300 so that the sale product information is displayed on the web page of the seller 300 (operation 304 of FIG. 3). Accordingly, the web server 330 of the seller 300 may display sale product information through the web page of the seller 300 (operation 305 of FIG. 3).

According to an embodiment of the present disclosure, the web server 160 of the intermediation core 100 and the web server 330 of the seller 300 may be synchronized with each other and share the sale product information in real time.

In an embodiment, in operation 26, the electronic commerce intermediating system 10 may make a database of sale product information and store the same in the DB server 150. For example, the DB server 150 of the intermediation core 100 may make a database of the sale product information received from the web server 160 and store the same.

In an embodiment, in operation 27, when the purchase product information is received from the web server 330 of the seller 300, the electronic commerce intermediating system 10 may transmit the purchase product information to the web server of the supplier 200. For example, the web server 330 of the seller 300 may receive an input of purchase product information from the purchaser and transmit the purchase product information to the web server 160 of the intermediation core 100 (operations 306 and 307 of FIG. 3). The web server 160 of the intermediation core 100 may transmit the purchase product information to the web server 230 of the supplier 200 and the DB server 150 of the intermediation core 100 (operation 308 of FIG. 3). The DB server 150 of the intermediation core 100 may make a database of the purchase product information and store the same.

For example, the purchase product information may include a name of the purchase product, a quantity, and a payment price.

In an embodiment, the electronic commerce intermediating system 10 may check a payment price from the purchase product information of the purchaser through the payment management server 120, subtract the same amount corresponding to the payment price from the deposit, and determine a resultant amount as a settlement amount.

In an embodiment, in operation 28, when delivery information is received from the web server 230 of the supplier 200, the electronic commerce intermediating system 10 may transmit the delivery information to the web server 330 of the seller 300. For example, when the delivery information is received from the supplier 200, the web server 160 of the intermediation core 100 may transmit the delivery information to the web server 330 of the seller 300 (operation 309 and operation 310 of FIG. 3).

For example, the delivery information may include a delivery status of the purchase product, such as a delivery location of the purchase product, whether delivery is completed, a delivery completion time, and a delivery accident.

In an embodiment, when purchase confirmation information is received, the electronic commerce intermediating system 10 may transfer the determined settlement amount (subtracted amount) to the supplier. For example, when the payment management server 120 receives the purchase confirmation information through the web server 330 of the seller 300, the payment management server 120 may transfer the settlement amount to the web server 230 or the DB server 220 of the supplier 200. For example, the purchase confirmation information may include contents of approving receipt of the product through the web page of the seller 300 after the purchaser receives the product.

Meanwhile, according to an embodiment of the disclosure, the central management server 110 of the intermediation core 100 may perform all of the operations 21 to 28, transmit the commands of the operations, and transmit a result of each command. That is, the central management server 110 may overall manage the electronic commerce intermediating system 10 of the present disclosure.

For a smooth understanding of the disclosure, the operation of the disclosure based on the deposit, the payment price, and settlement amount of the present disclosure will be described in detail as follows.

In an embodiment, the electronic commerce intermediating system 10 may receive a deposit (e.g., 10 million won) from the seller 300, provide a price (e.g., 70,000 won) of a supply product or service of the supplier 200 to the seller 300, receive a purchase input (e.g., purchase price of 100,000 won) through the web page of the seller 300, check a current amount of the deposit by subtracting the price of the supply product or service from the deposit (e.g., 10 million won—70,000 won), determine the price of the supply product or service as a settlement amount (e.g. 70,000 won), and request delivery from the supplier 200. When confirmation information indicating that the supplier 200 has sent the supply product or provided a service is received from the purchaser, the settlement amount may be transferred to the supplier 200. Here, as the settlement amount is transferred to the supplier 200, the deposit is reduced by the transmitted settlement amount (e.g., 9.93 million won). Of course, all of the above operations may be performed by the central management server 110, the payment management server 120, or the web server 160 of the intermediation core 100.

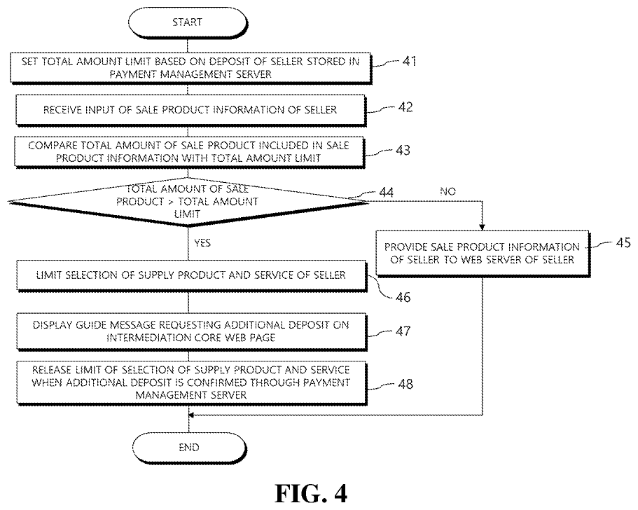

FIG. 4 is a flowchart illustrating a purchase restriction of the seller based on a deposit and a total amount limit according to an embodiment of the present disclosure.

Referring to FIG. 4, the electronic commerce intermediating system 10 according to an embodiment of the present disclosure may set a total amount limit based on the deposit of the seller 300 stored in the payment management server 120 in operation 41. For example, when the deposit is received from the seller 300, the payment management server 120 may set the total amount limit according to the amount of the deposit. For example, the total amount limit may be 0.8 to 2 times the deposit.

In an embodiment, in operation 42, the electronic commerce intermediating system 10 may receive an input of sale product information from the seller 300. For example, the web server 160 of the intermediation core 100 may receive the input of sale product information from the seller 300 through the intermediation core web page and transmit the received sale product information to the payment management server 120.

In an embodiment, in operation 43, the electronic commerce intermediating system 10 may compare a total amount of the sale product included in the sale product information with the total amount limit. For example, the payment management server 120 may calculate the total amount of the sale product based on the received sale product information and compare the total amount of the sale product with the preset total amount limit.

In an embodiment, in operation 44, the electronic commerce intermediating system 10 may check whether the total amount of the sale product is greater than the total amount limit as a result of the comparison. This may be an operation for a safety device for stably paying the settlement amount to the supplier 200 through the deposit of the seller 300.

In an embodiment, if the total amount of the sale product is smaller than the total amount limit, the electronic commerce intermediating system 10 may provide the sale product information of the seller 300 to the web server 330 of the seller 300 in operation 45.

Meanwhile, in an embodiment, if the total amount of the sale product is greater than the total amount limit, the electronic commerce intermediating system 10 may limit selection of a supply product and service of the seller 300. For example, the web server 160 of the intermediation core 100 may deactivate a selection menu so that the seller 300 may no longer select a supply product or service.

In an embodiment, in operation 47, the electronic commerce intermediating system 10 may display a guide message requesting an additional deposit on the intermediation core web page. For example, the web server 160 of the intermediation core 100 may display a guide message on the intermediation core web page in the form of a pop-up window.

In an embodiment, in operation 48, the electronic commerce intermediating system 10 may release restrictions on selection of a supply product and service when the additional deposit is confirmed through the payment management server 120. Accordingly, the seller 300 may again select a supply product or service.

Meanwhile, according to an embodiment of the disclosure, when the total deposit received is greater than the total amount as the seller 300 deposits the additional deposit, the payment management server 120 may reset the total amount limit based on the increased total amount of the deposit.

Meanwhile, according to an embodiment of the disclosure, the central management server 110 of the intermediation core 100 may perform all of the operations 41 to 48, transmits commands of the operations, and transmit a result of each command. That is, the central management server 110 may overall manage the electronic commerce intermediating system 10 of the present disclosure.

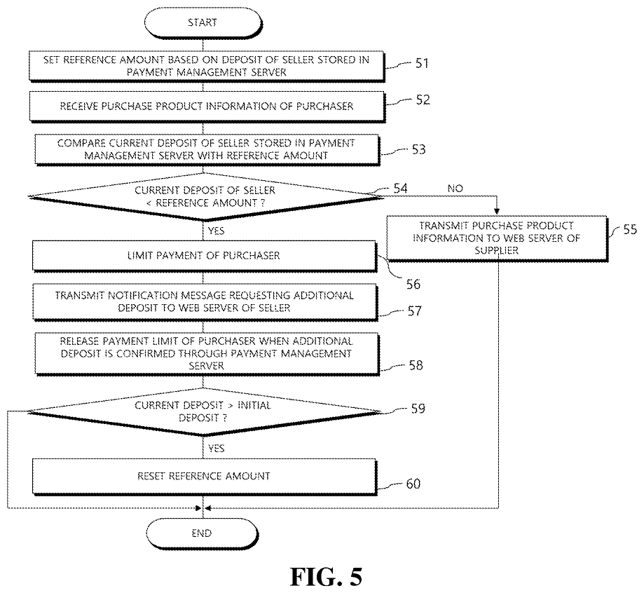

FIG. 5 is a flowchart illustrating a payment restriction of a purchaser in accordance with a deposit of a seller and a reference amount according to an embodiment of the present disclosure.

Referring to FIG. 5, the electronic commerce intermediating system 10 according to an embodiment of the present disclosure may set a reference amount based on the deposit of the seller 300 stored in the payment management server 120 in operation 51. For example, when receiving the deposit from the seller 300, the payment management server 120 may set a reference amount according to the amount of the initial deposit. Here, the initial deposit may be a total amount initially deposited by the seller 300 before purchasing a supply product or service. For example, the reference amount may be set within the range of 1% to 20% of the total amount of the initial deposit. Of course, the range of 1% to 20% or less may be an example, and the reference amount may be set within an appropriate range of the total amount of the deposit.

In an embodiment, in operation 52, the electronic commerce intermediating system 10 may receive purchase product information of the purchaser. For example, the web server 160 of the intermediation core 100 may receive purchase product information through the web server 330 of the seller 300.

In an embodiment, the electronic commerce intermediating system 10 may compare the current deposit of the seller 300 stored in the payment management server 120 with the reference amount in operation 53. Here, the current deposit may be the same as the initial deposit or may be an amount obtained by subtracting a settlement amount from the initial deposit at least once or more, and the reference amount may range from 1% to 20% of the total amount of the initial deposit.

In an embodiment, in operation 54, the electronic commerce intermediating system 10 may determine whether the current deposit of the seller 300 is smaller than the reference amount. That is, when the settlement amount is subtracted and the current deposit is lowered to a certain amount or less, there is a possibility that the settlement amount may not be paid to the supplier 200, and thus a stable transaction may be induced by setting a minimum reference amount and comparing the amounts.

In an embodiment, if the deposit of the seller 300 is greater than the reference amount, the electronic commerce intermediating system 10 may transmit the purchase product information to the web server 230 of the supplier 200 in operation 55.

Meanwhile, in an embodiment, if the deposit of the seller 300 is smaller than the reference amount, the electronic commerce intermediating system 10 may limit the payment of the purchaser in operation 56. For example, the payment management server 120 may transmit a command limiting the payment function of the intermediation core web page to the web server 160 of the intermediation core 100, and the web server 160 of the intermediation core 100 may deactivate the payment menu.

In an embodiment, the electronic commerce intermediating system 10 may transmit a notification message requesting an additional deposit to the web server 330 of the seller 300 in operation 57. For example, the web server 160 of the intermediation core 100 may transmit the notification message to the web server of the seller 300 or a smartphone of the seller 300 so that the seller 300 may know that purchase of the current purchaser is restricted.

In an embodiment, the electronic commerce intermediating system 10 may cancel the purchaser payment restriction when the additional deposit is confirmed through the payment management server 120 in operation 58. For example, the payment management server 120 may transmit a command for releasing the payment restriction to the web server 160, and the web server 160 may reactivate the deactivated payment menu.

In an embodiment, in operation 59, the electronic commerce intermediating system 10 may determine whether the current deposit to which the additional deposit is deposited is greater than the initial deposit. For example, the payment management server 120 may determine whether the amount of the current deposit is greater than the amount of the initial deposit due to the deposit of the additional deposit.

In an embodiment, if the current deposit is less than the initial deposit, the electronic commerce intermediating system 10 may terminate the corresponding procedure.

Meanwhile, in an embodiment, if the current deposit is larger than the initial deposit, the electronic commerce intermediating system 10 may reset the reference amount in operation 60. For example, the payment management server 120 may reset the reference amount to the range of 1% to 20% or less of the total amount of the increased deposit. Of course, the range of 1% to 20% or less may be an example, and the reference amount may be set within an appropriate range of the total amount of the deposit.

Meanwhile, according to an embodiment of the disclosure, the central management server 110 of the intermediation core 100 may perform all of the operations 51 to 57, transmit commands of the operations, and transmit a result of each command. That is, the central management server 110 may overall manage the electronic commerce intermediating system 10 of the present disclosure.

FIG. 6 is a flowchart illustrating an operation of an artificial intelligence server in an electronic commerce intermediating system according to an embodiment of the present disclosure.

Referring to FIG. 6, the electronic commerce intermediating system 10 according to an embodiment of the present disclosure may receive budget information, member information, target information, and domain information from the seller 300 in operation 61. For example, the web server 160 of the intermediation core 100 may receive budget information, member information, target information, and domain information from the web server 330 of the seller 300. Alternatively, the web server 160 of the intermediation core 100 may directly receive budget information, member information, target information, and domain information from the seller 300 through the intermediation core web page. Here, the budget information may include a total purchase price, that is, a deposit, of the sale product available to the seller 300, the member information may include a name, a business license, and the like of the seller 300, the target information may include a target product that the seller 300 wants to sell, a target group (e.g., women in her 20s), and the like, and the domain information may include a web page address of the seller 300. In addition, the web server 160 of the intermediation core 100 may transmit the budget information, the member information, the target information, and the domain information to the artificial intelligence server 130 and the DB server 150. The DB server 150 may make a database of the budget information, the member information, the target information, and the domain information and store the same.

In operation 62, the electronic commerce intermediating system 10 according to an embodiment of the present disclosure may transmit a web page created based on information received from the seller 300 to the web server of the seller 300. For example, the artificial intelligence server 130 may create a web page suitable for the seller 300 by comprehensively analyzing the budget information, the member information, the target information, and the domain information as a database and provide the created web page to the seller 300.

In operation 63, the electronic commerce intermediating system 10 according to an embodiment of the present disclosure may analyze the supply product and service information, the sale product information, and the purchase product information stored in the DB server 150. For example, the artificial intelligence server 130 may determine a recommended product having a high recent purchase rate by analyzing the supply product and service information, the sale product information, and the purchase product information as a database.

In operation 64, the electronic commerce intermediating system 10 according to an embodiment of the present disclosure may provide a list of recommended products to the web server of the seller 300 based on the analysis result. For example, the artificial intelligence server 130 may transmit a list including recommended products obtained as a result of analysis to the web server 330 of the seller 300.

In operation 65, the electronic commerce intermediating system 10 according to an embodiment of the present disclosure may determine whether additional supply product and service information is received from the supplier 200.

If additional supply product and service information is not received from the supplier 200, the electronic commerce intermediating system 10 may terminate the procedure.

Meanwhile, if additional supply product and service information is received from the supplier 200, the electronic commerce intermediating system 10 according to an embodiment of the present disclosure may provide a list of additional supply products and services to the web server 330 of the seller 300 based on the additional supply product and service information in operation 66. For example, the artificial intelligence server 130 or the web server 160 of the intermediation core 100 may transmit the list of additional products and services to the web server 330 of the seller 300.

Meanwhile, according to an embodiment of the present disclosure, operations disclosed in FIG. 6 of the electronic commerce intermediating system 10 may have different order of operations. For example, operations 63 and 64 may be performed after operations 65 and 66 are first performed. That is, the operations of the electronic commerce intermediating system may be performed differently from that disclosed in FIG. 6.

Meanwhile, according to an embodiment of the disclosure, the central management server 110 of the intermediation core 100 may perform all of the operations 61 to 66, transmits commands of the operations, and transmit a result of each command. That is, the central management server 110 may overall manage the electronic commerce intermediating system 10 of the present disclosure.

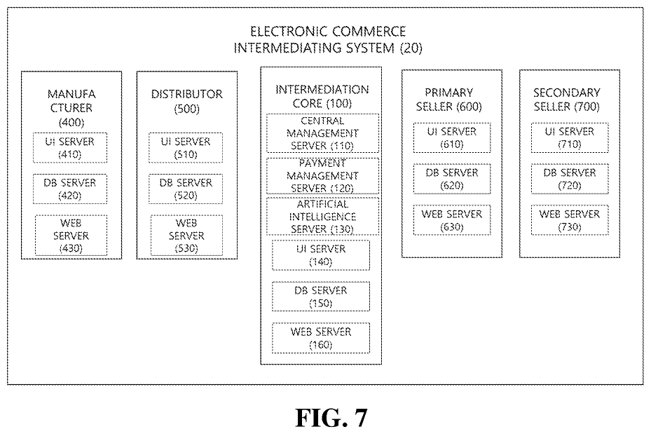

FIG. 7 is a block diagram illustrating an electronic commerce intermediating system according to another embodiment of the present disclosure. Hereinafter, descriptions overlapping with those of FIG. 1 in FIG. 7 will be omitted.

Referring to FIG. 7, electronic commerce among a manufacturer 400, a distributor 500, a primary seller 600, a secondary seller 700, and a purchaser according to another embodiment of the present disclosure may be performed through an electronic commerce intermediating system 20. For example, the manufacturer 400, the distributor 500, the primary seller 600, and the secondary seller 700 may join the electronic commerce intermediating system 20 as a member through the intermediation core web page, and the manufacturer 400 and the distributor 500 may register products and services they manufacture and products and services they distribute in the electronic commerce intermediating system 20, and the primary seller 600 and the secondary seller 700 may view, retrieve, select, and sell the registered supply products and services.

The electronic commerce intermediating system 20 according to an embodiment of the present disclosure may include an intermediation core 100 part, a manufacturer 400 part, a distributor 500 part, a primary seller 600, and a secondary seller 700 part. The manufacturer 400 part, the distributor 500 part, the primary seller 600 and the secondary seller 700 part may perform transactions through the intermediation core 100 part. The intermediation core 100 part, the manufacturer 400 part, the distributor 500 part, the primary seller 600 and the secondary seller 700 part may have a concept of classifying multiple servers included in the electronic commerce intermediating system 20 on the basis of an operating subject, and devices in which the electronic commerce intermediating system 20 of the present disclosure operates are servers disclosed in FIG. 7 to be described below.

In an embodiment, a general description of each server of the intermediation core 100 part is the same as the description disclosed in FIG. 1 and thus a description thereof will be omitted. However, the central management server 110, the payment management server 120, the artificial intelligence server 130, the UI server 140, the DB server 150, and the web server 160 may additionally manage the distributor 500 and the secondary seller 700 unlike FIG. 1. A management method thereof is the same as the method of FIG. 1.

For example, in an embodiment, when distribution product information from the distributor 500 is registered, the central management server 110 may update it to the DB server 150 in real time and inform the web server 630 of the primary seller 600.

For example, the payment management server 120 may store and manage a deposit of the primary seller 600, purchase product information of the purchaser, and a settlement amount of the distributor 500.

For example, the artificial intelligence server 130 may create a web page appropriate for the primary seller 600 or the secondary seller 700 by analyzing a huge amount of big data stored as a database in the DB server 150 of the intermediation core 100, the DB server 420 of the manufacturer 400, the DB server 520 of the distributor 500, the DB server 620 of the primary seller 600, and the DB server 720 of the secondary seller 700.

For example, the DB server 150 may make a database of supply product and service information, distribution product information, primary sale product information, secondary sale product information, purchase product information, and settlement amount and store the same.

For example, the web server 160 may provide the intermediation core web page to the manufacturer 400, the distributor 500, the primary seller 600, and the secondary seller 700.

In an embodiment, each server included in the manufacturer 400 part and the distributor 500 part may perform the same function as the respective servers of the supplier 200 part of FIG. 1, and each server included in the primary seller 600 part and the secondary seller 700 part may perform the same function as the respective servers of the seller 300 part of FIG. 1.

In an embodiment, the manufacturer 400 may transmit and receive data with the distributor 500, without directly transmitting and receiving data with each server of the intermediation core 100, and the distributor 500 may transmit supply product and service information and distribution product information with each server of the intermediation core 100. Of course, alternatively, the manufacturer 400 may directly transmit and receive data with each server of the intermediation core 100 without the distributor 500.

In an embodiment, the secondary seller 700 may transmit and receive data with the primary seller 600 without directly transmitting and receiving data with each server of the intermediation core 100, and the primary seller 600 may transmit primary sale product information and secondary sale product information with each server of the intermediation core 100. Of course, alternatively, the secondary seller 700 may directly transmit and receive data with each server of the intermediation core 100 without the primary seller 600.

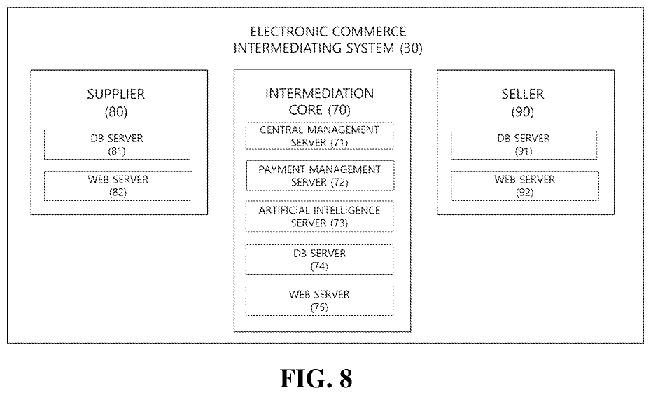

FIG. 8 is a block diagram illustrating an electronic commerce intermediating system according to another embodiment of the present disclosure. Hereinafter, descriptions overlapping with those of FIG. 1 in FIG. 8 will be omitted.

Referring to FIG. 8, in the electronic commerce intermediating system 30 according to another embodiment of the present disclosure, a UI server and a web server may be integrated, so that the web server may perform even the function of the UI server. Since the operation and function of the other components are the same as those of FIG. 1, a description thereof will be omitted.

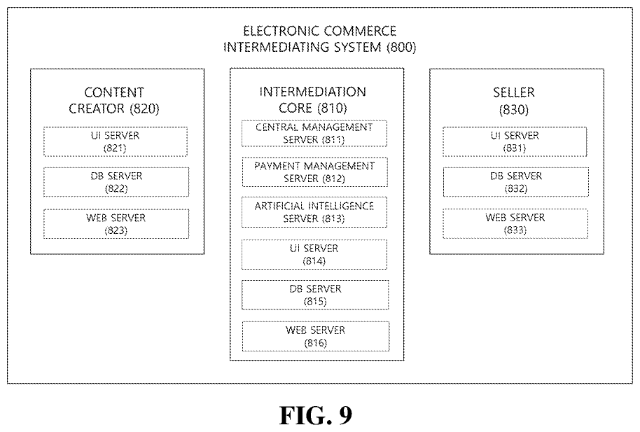

FIG. 9 is a block diagram illustrating an electronic commerce intermediating system according to another embodiment of the present disclosure. Hereinafter, descriptions overlapping with those of FIG. 1 in FIG. 9 will be omitted.

Referring to FIG. 9, an electronic commerce transaction among a content creator 820, a seller 830, and a purchaser according to the present disclosure may be performed through the electronic commerce intermediating system 10. Here, the content creator 820 may be a person who creates and supplies content, and the content may include music, video, an image, text, and the like. In an embodiment, the content creator 820 and the seller 830 may be subjects who run a business without being limited to any part of the world. For example, a business area of the content creator 820 and a business area of the seller 830 may both target the world.

The electronic commerce intermediating system 800 disclosed in FIG. 9 may perform the same functions and operations as the electronic commerce intermediating system 10 of FIG. 1, except that the content creator 820, instead of the supplier 200, creates content and provides the content to the seller 830 that supplies and sells the content. Therefore, detailed description of each server will be omitted.

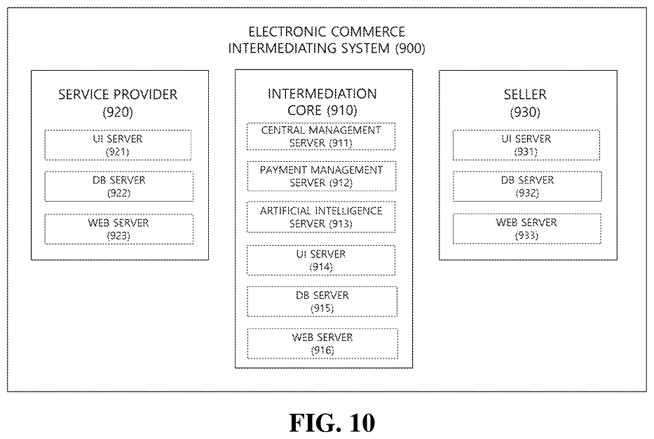

FIG. 10 is a block diagram illustrating an electronic commerce intermediating system according to another embodiment of the present disclosure. Hereinafter, descriptions overlapping with those of FIG. 1 in FIG. 10 will be omitted.

Referring to FIG. 10, an electronic commerce transaction among a service provider 920, a seller 930, and a purchaser according to the present disclosure may be performed through the electronic commerce intermediating system 10. Here, the service provider 920 may be a manpower company that provides services or an individual who provides services. The service provider 920 and the seller 930 may be entities who run a business without being limited to any part of the world. For example, business areas of the service provider 920 and the seller 930 may all target the world. Service has a concept including a variety of services that a person may provide. For example, the service may refer to a service that may be provided by an instructor, a singer, a freelance translator, or the like.

The electronic commerce intermediating system 900 disclosed in FIG. 10 may be perform the same functions and operations as those of the electronic commerce intermediating system 10 of FIG. 1, except that the service provider 920 instead of the supplier 200 provides the service to the seller 930. Therefore, detailed description of each server will be omitted.

According to various embodiments of the present disclosure, a system for intermediating an electronic commerce between a supplier and a seller may include a central management server configured to manage supply product and service information received from a supplier and sale product information received from a seller, a payment management server configured to manage a deposit of the seller, a purchase product information of a purchaser, and a settlement amount of the supplier, an intermediation core DB server configured to make a database of the supply product and service information, the sale product information, the purchase product information, the deposit, and the settlement amount and to store the database, an intermediation core web server configured to provide an intermediation core web page, and a web server of the seller configured to provide a web page of the seller, wherein the intermediation core web server may be configured to receive the supply product and service information input from the supplier through the intermediation core web page, to provide the supply product and service information to the seller through the intermediation core web page, to receive the sale product information input from the seller through the intermediation core web page, and to transmit the sale product information to the web server of the seller so that the sale product information is linked to the web page of the seller.

According to various embodiments of the present disclosure, the web server of the seller may be configured to provide the web page of the seller including the sale product information to the purchaser as the sale product information is received.

According to various embodiments of the present disclosure, the web server of the seller may be configured to receive the purchase product information through the web page of the seller and to transmit the purchase product information to the intermediation core web server.

According to various embodiments, the system for intermediating electronic between a supplier and a seller may further include a web server of the supplier, wherein the intermediation core web server may be configured to transmit the received purchase product information to the web server of the supplier and to receive delivery information corresponding to the purchase product information from the web server of the supplier.

According to various embodiments of the present disclosure, the intermediation core web server may be configured to transmit the received delivery information to the web server of the seller.

According to various embodiments, the supplier may include a manufacturer that manufactures a supply product and service and a distributor that distributes a supply product and service.

According to various embodiments, the central management server may be configured to receive the supply product and service information from the manufacturer or to receive the supply product and service information from the distributor.

According to various embodiments, the seller may include a primary seller and a secondary seller.

According to various embodiments, the central core web server may be configured to provide the supply product and service information to the primary seller through the intermediation core web page, to receive primary sale product information from the primary seller through the intermediation core web page, and to transmit the primary sale product information to a web server of the primary seller so that the primary sale product information is linked to a web page of the primary web seller.

According to various embodiments, the web server of the primary seller may be configured to receive secondary sale product information from the secondary seller through the web page of the primary seller and to transmit the secondary sale product information to the web server of the secondary seller so that the secondary sale product information is linked to a web page of the secondary seller.

According to various embodiments, the supply product and service information may include at least one of description of the supply product and service, a quantity in stock, the number of available service providers, a supply price, a consumer price, a delivery charge, or a category.

According to various embodiments, the sale product information may include at least one of a name and description of a product selected by the seller among supply products and services, contents of a service, the number of service personnel, a quantity of supply products, a consumer price, a delivery charge, or a category.

According to various embodiments of the present disclosure, the payment management server may be configured to set a total amount limit based on the deposit of the seller stored in the payment management server, to compare a total amount of a sale product included in the sale product information with the total amount limit, and to limit selection of a supply product and service of the seller when the total amount of the sale product is greater than the total amount limit.

According to various embodiments of the present disclosure, the intermediation core web server may be configured to display a guide message requesting an additional deposit on the intermediation core web page.

According to various embodiments of the present disclosure, the payment management server may be configured to release the limit of selection of the supply product and service when the additional deposit of the seller is confirmed.

According to various embodiments, the payment management server may be configured to set a reference amount based on the deposit of the seller, to compare a current deposit of the seller with the reference amount when the purchase product information of the purchaser is received through the web server of the seller, and to limit payment of the purchaser when the current deposit of the seller is smaller than the reference amount.

According to various embodiments of the present disclosure, the payment management server may be configured to transmit a notification message requesting an additional deposit to the web server of the seller or an electronic device of the seller.

According to various embodiments of the present disclosure, the payment management server may be configured to release the limit of payment of the purchaser when the additional deposit is confirmed.

According to various embodiments, the payment management server may be configured to reset the reference amount based on an increased deposit, when an amount of the current deposit is greater than an initial deposit due to payment of the additional deposit.

According to various embodiments, the payment management server may be configured to transmit a notification message requesting the additional deposit to the web server of the seller or an electronic device of the seller.

According to various embodiments of the present disclosure, the payment management server may be configured to release the limit of payment of the purchaser when the additional deposit is confirmed.

According to various embodiments, the system for intermediating an electronic commerce between a supplier and a seller may further include an artificial intelligence server, wherein the artificial intelligence server may be configured to create a web page based on budget information, member information, target information, and domain information received from the seller and to transmit the created web page to the web server of the seller.

According to various embodiments, the artificial intelligence server may be configured to analyze the supply product and service information, the sale product information, and the purchase product information stored in the DB server and to provide a recommendation product list to the web server of the seller based on a result of the analysis.

According to various embodiments, the artificial intelligence server may be configured to provide an additional supply product and service list to the web server of the seller based on additional supply product and service information, when the additional supply product and service information is received from the supplier.

According to various embodiments, the supplier may include a content creator providing content and a service provider.

According to various embodiments of the present disclosure, the central management server may be configured to receive content information from the content creator, and the content comprises video, an image, music, news, and text.

According to various embodiments, the central management server may be configured to receive service information from the service provider, and the service information comprises contents of a providable service and available personnel.

According to various embodiments of the present disclosure, a method of intermediating an electronic commerce between a supplier and a seller including a central management server configured to manage supply product and service information received from a supplier and sale product information received from a seller, a payment management server configured to manage a deposit of the seller, a purchase product information of a purchaser, and a settlement amount of the supplier, an intermediation core DB server configured to make a database of the supply product and service information, the sale product information, the purchase product information, the deposit, and the settlement amount and to store the database, an intermediation core web server configured to provide an intermediation core web page, and a web server of the seller configured to provide a web page of the seller, may include receiving the supply product and service information input from the supplier through the intermediation core web page, providing supply product and service information to the seller through the intermediation core web page, receiving the sale product information input from the seller through the intermediation core web page, and transmitting the sale product information to the web server of the seller so that the sale product information is linked to the web page of the seller.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

[Description of Reference Numerals]

| | |
|---|---|
| 10, 20, 800, 900: electronic | |
| commerce intermediating system | |
| 100: intermediation core | |
| 110: central management server | 120: payment management server |
| 130: artificial intelligence server | 140: UI server |
| 150: DB server | 160: web server |
| 200: supplier | 210: UI server |
| 220: DB server | 230: web server |
| 300: seller | 310: UI server |
| 320: DB server | 330: web server |
| 400: manufacturer | |
| 500: distributor | |
| 600: primary seller | |
| 700: secondary seller | |
| 810: intermediation core | 820: content creator |
| 830: seller | |
| 910: intermediation core | 920: service provider |
| 930: seller | |

### INDUSTRIAL AVAILABILITY

The present disclosure relates to a system and method for intermediating an electronic commerce between a supplier and a seller, whereby transactions may be made with multiple sellers even if multiple supplies upload only a list of supply products and services, and thus transactions of the supply products and services of the suppliers may be promoted, distribution channels for supply products and services may be easily diversified, and it may be used in fields such as electronic commerce or the like.

What is claimed is:

1. A system for intermediating an electronic commerce between a supplier and a seller, the system comprising:
a central management server configured to manage supply product and service information received from a supplier and sale product information received from a seller;
a payment management server configured to manage a deposit of the seller, a purchase product information of a purchaser, and a settlement amount of the supplier;
an intermediation core DB server configured to make a database of the supply product and service information, the sale product information, the purchase product information, the deposit, and the settlement amount and to store the database;
an intermediation core web server configured to provide an intermediation core web page; and
a web server of the seller configured to provide a web page of the seller,
wherein the intermediation core web server is configured to receive the supply product and service information input from the supplier through the intermediation core web page, to provide the supply product and service information to the seller through the intermediation core web page, to receive the sale product information input from the seller through the intermediation core web page, and to transmit the sale product information to the web server of the seller so that the sale product information is linked to the web page of the seller.

2. The system of claim 1, wherein
the web server of the seller is configured to provide the web page of the seller including the sale product information to the purchaser as the sale product information is received.

3. The system of claim 1, wherein
the web server of the seller is configured to receive the purchase product information through the web page of the seller and to transmit the purchase product information to the intermediation core web server.

4. The system of claim 3, further comprising:
a web server of the supplier,
wherein the intermediation core web server is configured to transmit the received purchase product information to the web server of the supplier and to receive delivery information corresponding to the purchase product information from the web server of the supplier.

5. The system of claim 4, wherein
the intermediation core web server is configured to transmit the received delivery information to the web server of the seller.

6. The system of claim 1, wherein
the supplier comprises a manufacturer that manufactures a supply product and service and a distributor that distributes a supply product and service.

7. The system of claim 6, wherein
the central management server is configured to receive the supply product and service information from the manufacturer or to receive the supply product and service information from the distributor.

8. The system of claim 1, wherein
the seller comprises a primary seller and a secondary seller.

9. The system of claim 8, wherein
the central core web server is configured to provide the supply product and service information to the primary seller through the intermediation core web page, to receive primary sale product information from the primary seller through the intermediation core web page, and to transmit the primary sale product information to a web server of the primary seller so that the primary sale product information is linked to a web page of the primary web seller.

10. The system of claim 9, wherein
the web server of the primary seller is configured to receive secondary sale product information from the secondary seller through the web page of the primary seller and to transmit the secondary sale product information to the web server of the secondary seller so that the secondary sale product information is linked to a web page of the secondary seller.

11. The system of claim 1, wherein
the supply product and service information comprises at least one of a description of a supply product and service, a quantity in stock, the number of available service providers, a supply price, a consumer price, a delivery charge, or a category.

12. The system of claim 1, wherein
the sale product information comprises at least one of a name and description of a product selected by the seller among supply products and services, contents of a service, the number of service personnel, a quantity of supply products, a consumer price, a delivery charge, or a category.

13. The system of claim 1, wherein
the payment management server is configured to set a total amount limit based on the deposit of the seller stored in the payment management server, to compare a total amount of a sale product included in the sale product information with the total amount limit, and to limit selection of a supply product and service of the seller when the total amount of the sale product is greater than the total amount limit.

14. The system of claim 13, wherein
the intermediation core web server is configured to display a guide message requesting an additional deposit on the intermediation core web page.

15. The system of claim 14, wherein
the payment management server is configured to release the limit of selection of the supply product and service when the additional deposit of the seller is confirmed.

16. The system of claim 1, wherein
the payment management server is configured to set a reference amount based on the deposit of the seller, to compare a current deposit of the seller with the reference amount when the purchase product information of the purchaser is received through the web server of the seller, and to limit payment of the purchaser when the current deposit of the seller is smaller than the reference amount.

17. The system of claim 16, wherein
the payment management server is configured to transmit a notification message requesting an additional deposit to the web server of the seller or an electronic device of the seller.

18. The system of claim 17, wherein
the payment management server is configured to release the limit of payment of the purchaser when the additional deposit is confirmed.

19. The system of claim 18, wherein
the payment management server is configured to reset the reference amount based on an increased deposit, when an amount of the current deposit is greater than an initial deposit due to payment of the additional deposit.

20. The system of claim 1, further comprising:
an artificial intelligence server,
wherein the artificial intelligence server is configured to create a web page based on budget information, member information, target information, and domain information received from the seller and to transmit the created web page to the web server of the seller.

21. The system of claim 20, wherein
the artificial intelligence server is configured to analyze the supply product and service information, the sale product information, and the purchase product information stored in the DB server and to provide a recommendation product list to the web server of the seller based on a result of the analysis.

22. The system of claim 20, wherein
the artificial intelligence server is configured to provide a list of additional supply products and services to the web server of the seller based on additional supply product and service information, when the additional supply product and service information is received from the supplier.

23. The system of claim 1, wherein
the supplier comprises a content creator providing content and a service provider.

24. The system of claim 23, wherein
the central management server is configured to receive content information from the content creator, and the content comprises video, an image, music, news, and text.

25. The system of claim 23, wherein
the central management server is configured to receive service information from the service provider, and the service information comprises contents of a providable service and available personnel.

26. A method of intermediating an electronic commerce between a supplier and a seller of an electronic commerce intermediating system including a central management server configured to manage supply product and service information received from a supplier and sale product information received from a seller, a payment management server configured to manage a deposit of the seller, a purchase product information of a purchaser, and a settlement amount of the supplier, an intermediation core DB server configured to make a database of the supply product and service information, the sale product information, the purchase product information, the deposit, and the settlement amount and to store the database, an intermediation core web server configured to provide an intermediation core web page, and a web server of the seller configured to provide a web page of the seller, the method comprising:
receiving the supply product and service information input from the supplier through the intermediation core web page;
providing supply product and service information to the seller through the intermediation core web page;
receiving the sale product information input from the seller through the intermediation core web page; and
transmitting the sale product information to the web server of the seller so that the sale product information is linked to the web page of the seller.
